(19) United States
(12) Patent Application Publication
(10) Pub. No.: US 2011/0218800 A1
(43) Pub. Date: Sep. 8, 2011

(54) METHOD AND APPARATUS FOR OBTAINING PITCH GAIN, AND CODER AND DECODER

(75) Inventors: Dejun Zhang, Shenzhen (CN); Lei Miao, Shenzhen (CN); Jianfeng Xu, Shenzhen (CN); Fengyan Qi, Shenzhen (CN); Qing Zhang, Shenzhen (CN); Lixiong Li, Shenzheng (CN); Fuwei Ma, Shenzhen (CN)

(73) Assignee: Huawei Technologies Co., Ltd., Shenzhen (CN)

(21) Appl. No.: 13/109,679

(22) Filed: May 17, 2011

Related U.S. Application Data
(63) Continuation of application No. PCT/CN2009/076232, filed on Dec. 30, 2009.

(30) Foreign Application Priority Data
Dec. 31, 2008 (CN) 200810247428.0

(51) Int. Cl. G10L 21/00

(52) U.S. Cl. 704/207; 704/E11.006

(57) ABSTRACT

The present invention relates to a method and apparatus for obtaining a pitch gain, and a coder and a decoder. The method includes: obtaining information about an input signal; and obtaining a pitch gain corresponding to the information about the input signal according to the correspondence between the signal information and the pitch gain. The embodiments of the present invention obtain the corresponding pitch gain according to the signal information by using the obtained correspondence between the signal information and the pitch gain, and the pitch gain is applicable to the coder and the decoder, thus making it unnecessary for the coder to transmit the pitch gain to the decoder and solving the problem of bit overhead. The embodiments of the present invention determine the pitch gain adaptively according to the signal information, avoid consumption of extra bits for quantizing the pitch gain, avoid impact on the coding performance, and improve the compression ratio.

### CROSS-REFERENCE TO RELATED APPLICATIONS

This application is a continuation of International Application No. PCT/CN2009/076232, filed on Dec. 30, 2009, which claims priority to Chinese Patent Application No. 200810247428.0, filed on Dec. 31, 2008, both of which are hereby incorporated by reference in their entireties.

### TECHNICAL FIELD

The present invention relates to communication technologies, and in particular, to a method and apparatus for obtaining a pitch gain, and a coder and a decoder.

### BACKGROUND

Generally, in the speech coding field, speech and video signals are somewhat periodic. The long-term periodicity in the speech and video signals may be removed through a Long Term Prediction (LTP) method. For lossy compression and lossless compression, the pitch gain obtained through LTP needs to be quantized before coding.

In the foregoing solution provided in the prior art, the pitch gain is quantized before coding. The quantization consumes plenty of extra bits, and reduces the compression ratio.

### SUMMARY

The embodiments of the present invention provide a method and apparatus for obtaining a pitch gain, and a coder and a decoder to avoid consumption of extra bits for quantizing the pitch gain and improve the compression ratio.

A method for obtaining a pitch gain includes:

obtaining signal information about an input signal; and

obtaining a pitch gain corresponding to the signal information about the input signal according to the correspondence between the signal information and the pitch gain.

An apparatus for obtaining a pitch gain includes:

a signal information obtaining module, adapted to obtain signal information about an input signal; and

a pitch gain obtaining module, adapted to obtain a pitch gain corresponding to the signal information about the input signal according to the correspondence between the signal information and the pitch gain.

A coder includes the foregoing apparatus for obtaining a pitch gain.

A decoder includes the foregoing apparatus for obtaining a pitch gain.

### BRIEF DESCRIPTION OF THE DRAWINGS

To make the technical solution under the present invention or in the prior art clearer, the accompanying drawings for illustrating the embodiments of the present invention or illustrating the prior art are outlined below. Evidently, the accompanying drawings are exemplary only, and those skilled in the art can derive other drawings from such accompanying drawings without creative work.

FIG. 1 is a flowchart of a method for obtaining a pitch gain in a first embodiment of the present invention;

FIG. 2 is a flowchart, of a method for obtaining a pitch gain in a second embodiment of the present invention; and

FIG. 3 shows a structure of an apparatus for obtaining a pitch gain in a third embodiment of the present invention.

### DETAILED DESCRIPTION

The technical solution under the present invention is expounded below with reference to accompanying drawings. Evidently, the embodiments given herein are exemplary only and the present invention is not limited to such embodiments. Those skilled in the art can derive other embodiments from the embodiments without creative work, and all such embodiments are covered by the scope of protection of the present invention.

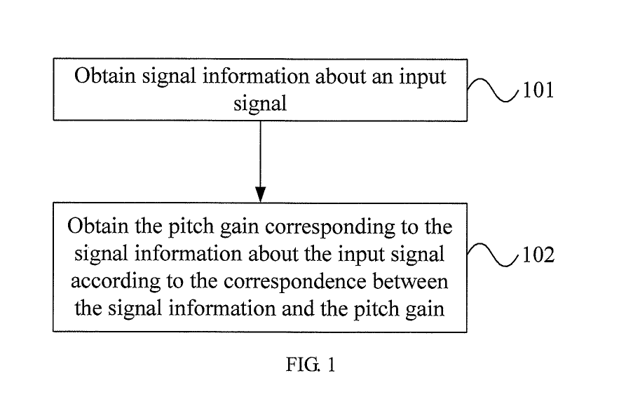

FIG. 1 is a flowchart of a method for obtaining a pitch gain in the first embodiment of the present invention. As shown in FIG. 1, the method may include the following steps:

Step 101: Obtain signal information about an input signal.

Step 102: Obtain the pitch gain corresponding to the signal information about the input signal according to the correspondence between the signal information and the pitch gain.

The signal information in this embodiment may include: pitch period, energy, zero crossing rate, or type information related to the signal. This embodiment obtains the correspondence between the signal information and the pitch gain beforehand, and obtains the corresponding pitch gain according to the signal information by using the correspondence, and the obtaining way of the pitch gain is applicable to the coder and the decoder, thus making it unnecessary for the coder to transmit the pitch gain to the decoder and solving the problem of bit overhead. This embodiment determines the pitch gain adaptively according to the signal information, avoids consumption of extra bits for quantizing the pitch gain, avoids impact on the coding performance, and improves the compression ratio.

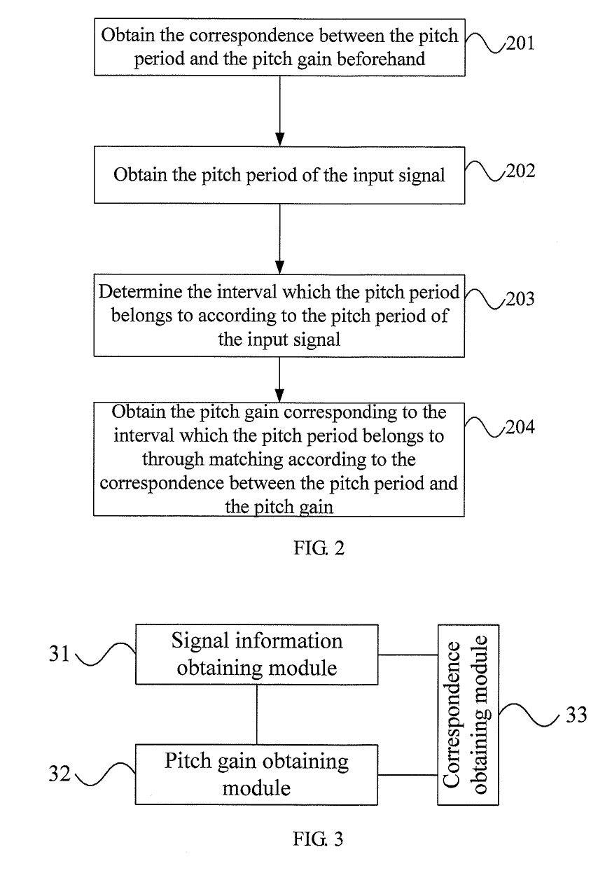

FIG. 2 is a flowchart of a method for obtaining a pitch gain in the second embodiment of the present invention. As shown in FIG. 2, the signal information in this embodiment is a pitch period, and the method in this embodiment may include the following steps:

Step 201: Obtain the correspondence between a pitch period and a pitch gain beforehand.

The correspondence between the pitch period and the pitch gain may be the correspondence between the interval which the pitch period belongs to and the fixed pitch gain. Specifically, at least one interval may be set in the range of the pitch period. Each interval corresponds to a fixed pitch gain.

Step 202: Obtain the pitch period of an input signal.

Step 203: Determine the interval which the pitch period belongs to according to the pitch period of the input signal.

Step 204: Obtain the pitch gain corresponding to the interval which the pitch period belongs to through matching according to the correspondence between the pitch period and the pitch gain.

The interval which the signal information about the input signal belongs to is determined according to the signal information about the input signal. The interval may be an interval set in the region of the signal information. At least one interval is set in the region of the signal formation.

The pitch gain corresponding to the interval which the signal information about the input signal belongs to is obtained.

The method in this embodiment is applicable to the coder and the decoder, as detailed below:

The LTP contribution of each of n subframes (n is a positive integer equal to or greater than 1) obtained by calculation is:

resⱼ′(n)=g[j]·resⱼ(n−Tⱼ), j=0, 1, K, n−1

where: T[j] is the pitch period of subframe j; g[j] is the pitch gain of subframe j; resⱼ(n−Tⱼ) is the LPC residual signal; and resⱼ′(n) is the LTP contribution signal. In LTP, the previous signal is used to predict the current signal. If the previous signal is closer to the current signal, the corresponding pitch period T[j] is smaller. That shows that if the similarity is higher, the pitch gain g[j] is greater.

In this embodiment, according to the following rules, the range of the pitch period may be divided into several intervals, and each interval corresponds to a fixed pitch gain. For example, the range of the pitch period is divided into two intervals. Interval 1 is [Tmin, FAC], and interval 2 is [FAC, Tmax]. Tmin is the minimum value of the pitch period, and may be a positive integer selected empirically, such as, 20; Tmax is the maximum value of the pitch period, and may be a positive integer selected empirically, such as, 83; and FAC is a boundary value between two intervals, and may be a positive integer selected empirically, such as, 40. In two intervals, the interval 1 corresponds to the pitch gain g1, the interval 2 corresponds to pitch gain g2, and therefore, the pitch gain of each subframe may be expressed as:

For each sub_frame j
if (T[j]<FAC)

gain[j]=g1 g1 ≧ g2

else

gain[j]=g2

The pitch gain of each subframe may also be expressed as: For each sub_frame j:

$$gain [ j ] = \{ \begin{matrix}{g}_{1} , T [ j ] < FAC \\ {g}_{2} , T [ j ] \geq FAC\end{matrix}$$

where, FAC is a threshold of the pitch period, and g1 and g2 are empirical values of the pitch gain in the LTP; distinct pitch periods corresponding to distinguishable pitch gains are considered. A decoder can perform decode as normal without transmitting gain parameter, because the decoder can determine the pitch gain by using pitch period parameter transmitted to the decoder. The determining way of the subframe pitch gain adaptively according to known pitch period of the decoder is the same as that of the coder.

Further, in the lossless compression algorithm, the LTP module is enabled only if it brings a forward effect. Statistics shows that when the LTP module brings a forward effect, the pitch gain of the LTP is relatively high, and fluctuates within a small range. Therefore, this embodiment may set the LTP gain g[j] to a fixed value uniformly. For example, the range of the pitch period is not divided in this embodiment; that is, the range is only one interval. The range (interval) of the pitch period corresponds to the pitch gain g3, and the pitch gain of each subframe is expressed as:

For each sub_frame j

gain[j]=g3

where g3 is an empirical value of the pitch gain in the LTP.

This embodiment obtains the corresponding pitch gain according to the pitch period of each subframe by using the obtained correspondence between the pitch period and the pitch gain, and the pitch gain is applicable to the coder and the decoder, thus making it unnecessary for the coder to transmit the pitch gain to the decoder and solving the problem of bit overhead. This embodiment can determine the pitch gain adaptively according to the pitch period, avoid consumption of extra bits for quantizing the pitch gain, avoid impact on the coding performance, and improve the compression ratio.

Alternatively, the pitch gain in this embodiment may be determined according to other signal-related information such as energy, zero crossing rate, or type information. For example, the range of the zero crossing rate is set to two intervals, and the pitch gains corresponding to the two intervals are g4 and g5 (g4≧g5). A threshold of the zero crossing rate is set. The threshold may be a positive integer selected empirically, such as, 25. When the zero crossing rate of the input signal is less than the threshold, the pitch gain of the input signal is g4; when the zero crossing rate of the input signal is greater than the threshold, the pitch gain of the input signal is g5. That is, if the zero crossing rate is higher, the input signal is closer to the unvoiced sound, and a lower pitch gain should be used; if the zero crossing rate is lower, the input signal is closer to the voiced sound, and a higher pitch gain should be used.

FIG. 3 shows a structure of an apparatus for obtaining a pitch gain in the third embodiment of the present invention. As shown in FIG. 3, the apparatus may include: a signal information obtaining module 31, adapted to obtain signal information about an input signal; and a pitch gain obtaining module 32, adapted to obtain the pitch gain corresponding to the signal information about the input signal obtained by the signal information obtaining module 31 according to the correspondence between the signal information and the pitch gain. The signal information in this embodiment may include: pitch period, energy, zero crossing rate, or type information related to the signal.

Further, the apparatus in this embodiment may include a correspondence obtaining module 33, adapted to obtain the correspondence between the signal information and the pitch gain so that the pitch gain obtaining module 32 can obtain the pitch gain corresponding to the signal information about the input signal obtained by the signal information obtaining module 31.

In this embodiment, the pitch gain obtaining module can obtain the pitch gain corresponding to the signal information of each subframe obtained by the signal information obtaining module according to the correspondence between the signal information and the pitch gain, where the correspondence is obtained by the correspondence obtaining module beforehand. The pitch gain obtaining module in this embodiment can determine the pitch gain adaptively according to the signal information, avoid consumption of extra bits for quantizing the pitch gain, avoid impact on the coding performance, and improve the compression ratio.

The apparatus in this embodiment may be located in the coder and the decoder separately so that the coder does not need to transmit the pitch gain to the decoder, thus solving the problem of bit overhead.

Further, a coder and a decoder are provided in an embodiment of the present invention. The coder and the decoder include the apparatus mentioned in the third embodiment above.

It is understandable to those skilled in the art that all or part of the steps of the foregoing method embodiments may be implemented by hardware instructed by a program. The program may be stored in a computer-readable storage medium. When being executed, the program performs steps of the foregoing method embodiments. The storage medium may be any medium suitable for storing program codes, for example, a Read Only Memory (ROM), a Random. Access Memory (RAM), a magnetic disk, or a compact disk.

Although the invention is described through several exemplary embodiments, the invention is not limited to such embodiments. It is apparent that those skilled in the art can make modifications and variations to the invention without departing from the spirit and scope of the invention. The invention is intended to cover the modifications and variations provided that they fall in the scope of protection defined by the following claims or their equivalents.

What is claimed is:

1. A method for obtaining a pitch gain, the method comprising:
obtaining signal information about an input signal; and
obtaining the pitch gain corresponding to the signal information about the input signal according to the correspondence between the signal information and the pitch gain.

2. The method according to claim 1 wherein the method further comprises:
obtaining the correspondence between the signal information and the pitch gain beforehand.

3. The method according to claim 1 wherein the step of obtaining the pitch gain corresponding to the signal information about the input signal according to the correspondence between the signal information and the pitch gain comprise:
determining the interval which the signal information about the input signal belongs to according to the signal information about the input signal, wherein the interval is an interval set in the region of the signal information, at least one interval is set in the region of the signal formation; and
obtaining the pitch gain corresponding to the signal information about the input signal according to the interval.

4. The method according to claim 1 wherein the step of obtaining the pitch gain corresponding to the signal information about the input signal according to the correspondence between the signal information and the pitch gain comprises:
determining the interval which the signal information about the input signal belongs to according to the signal information about the input signal, wherein the interval is an interval set in the region of the signal information, at least one interval is set in the region of the signal formation; and
obtaining the pitch gain corresponding to interval which the signal information about the input signal belongs to as the pitch gain of the input signal.

5. The method according to claim 4 wherein the step of determining the interval which the signal information about the input signal belongs to according to the signal information about the input signal comprises:
comparing the signal information of each subframe with a threshold of interval; and
determining the interval which the signal information of each subframe belongs to according the result of the comparing.

6. The method according to claim 5 wherein the steps of comparing the signal information of each subframe with a threshold of interval; and determining the interval which the signal information of each subframe belongs to according the result of the comparing comprises:
comparing the signal information of each subframe with a boundary value between two intervals; and
determining one of the two intervals as the interval which the signal information about the input signal belongs to according the result of the comparing.

7. The method according to claim 6 wherein the steps of comparing the signal information of each subframe with a threshold of interval and determining the interval which the signal information of each subframe belongs to according the result of the comparing comprises:
comparing the signal information of a subframe with the threshold of interval;
when the signal information of a subframe is less than the threshold of interval, treating the interval having a upper bound being the threshold as the interval which the signal information of the subframe belongs to; otherwise, treating the interval having a lower bound being the threshold as the interval which the signal information of the subframe belongs to.

8. The method according to claim 3 wherein the step of obtaining the pitch gain corresponding to the signal information about the input signal according to the interval comprises:
treating the pitch gain corresponding to the interval which the signal information about the input signal belongs to as the pitch gain of the input signal.

9. The method according to claim 1 wherein the signal information comprises: pitch period, energy, zero crossing rate, or type information.

10. The method according to claim 1 wherein the method is applicable to at least one of a coder and a decoder.

11. The method according to claim 1 wherein the signal information comprises pitch period, and the correspondence between the signal information and the pitch gain is the correspondence between the pitch period and the pitch gain.

12. The method according to claim 11 wherein the step of obtaining the pitch gain corresponding to the signal information about the input signal according to the correspondence between the pitch period and the pitch gain comprises:
determining the interval which the pitch period about the input signal belongs to according to the pitch period about the input signal, wherein the interval is an interval set in the region of the pitch period, at least one interval is set in the region of the pitch period; and
obtaining the pitch gain corresponding to the interval which the pitch period about the input signal belongs to.

13. The method according to claim 1 wherein the signal information comprises zero crossing rate, and the correspondence between the signal information and the pitch gain is the correspondence between the zero crossing rate and the pitch gain, a higher zero crossing rate corresponds to a lower pitch gain and a lower zero crossing rate corresponds to a higher pitch gain.

14. An apparatus for obtaining a pitch gain, the apparatus comprising:
a signal information obtaining module, adapted to obtain signal information about an input signal; and
a pitch gain obtaining module, adapted to obtain the pitch gain corresponding to the signal information about the input signal according to the correspondence between the signal information and the pitch gain.

15. The apparatus according to claim 14 further comprising:
a correspondence obtaining module, adapted to obtain the correspondence between the signal information and the pitch gain.

16. A coder, wherein the coder comprises the apparatus for obtaining a pitch gain according to claim 14.

17. A decoder, wherein the decoder comprises the apparatus for obtaining a pitch gain according to claim 14.

18. A method for obtaining a pitch gain, the method comprising:
obtaining signal information about an input signal;
determining the interval which the signal information about the input signal belongs to according to the signal information about the input signal, wherein the interval is an interval set in the region of the signal information, at least one interval is set in the region of the signal formation; and
obtaining the pitch gain corresponding to interval which the signal information about the input signal belongs to as the pitch gain of the input signal.
